(19) United States
(12) Patent Application Publication
(10) Pub. No.: US 2011/0202544 A1
(43) Pub. Date: Aug. 18, 2011

(54) REAL TIME AGGREGATION AND FILTERING OF LOCAL DATA FEEDS

(75) Inventors: Sylvain Carle, Montreal (CA); Sebastien Provencher, Montreal (CA); Colin Surprenant, Mont-Royal (CA)

(73) Assignee: PRAIZED MEDIA INC., Montreal (CA)

(21) Appl. No.: 12/790,568

(22) Filed: May 28, 2010

Related U.S. Application Data
(60) Provisional application No. 61/303,836, filed on Feb. 12, 2010.
(60) Provisional application No. 61/303,843, filed on Feb. 12, 2010.
(60) Provisional application No. 61/303,847, filed on Feb. 12, 2010.

(51) Int. Cl. G06F 17/30

(52) U.S. Cl. 707/754; 707/812; 707/E17.044

(57) ABSTRACT

Geo-augmented data feeds are filtered based on a selection of one or more of filters to create a plurality of filtered data streams. The filtered data streams are then sent to one or more user applications for presenting to a user. For example, a user might arrange to be alerted to a data stream that references a particular location.

### CROSS REFERENCE TO RELATED APPLICATIONS

This application claims the benefit under 35 USC/303,836119(e) of the following U.S. provisional applications, the contents of which are herein incorporated by reference: 61/303,836, filed Feb. 12, 2010; and 61/303,843, filed Feb. 12, 2010, and __/______ filed Feb. 12, 2010.

### TECHNICAL FIELD

The present invention relates to methods and systems for real-time aggregation, geo-augmentation and filtering of data feeds.

### BACKGROUND OF THE INVENTION

The internet provides various methods by which communities of users can generate and share information, including blogs, social networking sites such as Twitter™, Facebook™, news-groups and discussion forums, etc. New methods and systems for facilitating social interaction and sharing of information amongst diverse communities of users are expected to emerge in the future.

A portion of this information shared on these systems is relevant to various other parties. For example, users will often share information about places they have visited, or products that they have used. They will also share information about their experiences, including those involved in dealings with various organizations. This information is of interest to numerous parties. For example someone could publish a description (e.g. within a blog, or on a social networking site) of their visit to a particular location and their activities while there, which may be of interest to tourist agencies and merchants local to that place. Similarly, a comment about a company's product or service may be of interest both to that company and its competitors.

### SUMMARY OF THE INVENTION

An aspect of the present invention provides a process in which data feeds from a plurality of local sources are processed to derive metadata defining a respective geographical context of each data feed.

An advantage of the first aspect of the present invention is that the metadata can be used to aggregate and filter the data feeds according to geographical context, thereby enabling users or interested parties to search for and locate information that is relevant to their particular geographical area of interest.

Another aspect of the present invention provides a process in which geo-augmented data feeds are aggregated and distributed to one or more interested parties. Each data feed is geo-augmented with metadata defining at least a respective geographical context of the data feed. Geo-augmented data feeds having common geographical context are aggregated together to generate an aggregate data feed, which is distributed to one or more interested parties based on predetermined criteria.

Another advantage of the second aspect of the present invention is that each interested party receives an aggregated data feed that is relevant to their particular geographical area of interest.

A third aspect of the present invention provides a process in which geo-augmented data feeds are aggregated and distributed to one or more users or interested parties. Each data feed is geo-augmented with metadata defining at least a respective geographical context of the data feed. Geo-augmented data feeds having common geographical context are aggregated together to generate an aggregate data feed, which is processed to generate alerts and notifications that are distributed to one or more users or interested parties based on predetermined criteria.

An advantage of the third aspect of the present invention is that each interested party receives real-time alerts and notifications that are relevant to their particular geographical area of interest.

A fourth aspect of the present invention parses the unstructured text of a plurality of geo-augmented data feeds to derive filtered data feed streams, each of which corresponds to a set of criteria.

An advantage of the fourth aspect of the present invention is to extract data feed targetting specific user needs and limit the number of data feeds only to those that are relevant to the user or the type of business.

### BRIEF DESCRIPTION OF THE DRAWINGS

Further features and advantages of the present invention will become apparent from the following detailed description, taken in combination with the appended drawings, in which:

FIG. 1 represents an example of the system architecture.

FIG. 2 represents an example of the architecture of the user application.

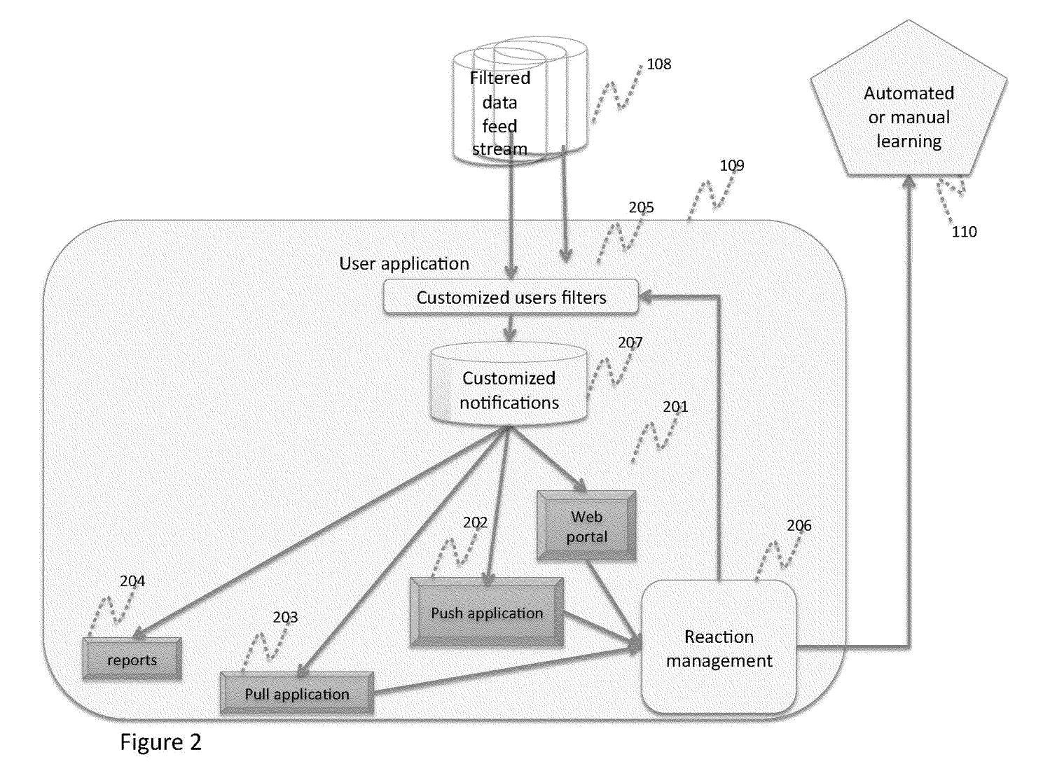

FIG. 3 provides an example of a user application interface displaying the filtered data streams

It will be noted that throughout the appended drawings, like features are identified by like reference numerals.

### DETAILED DESCRIPTION OF THE PREFERRED EMBODIMENT

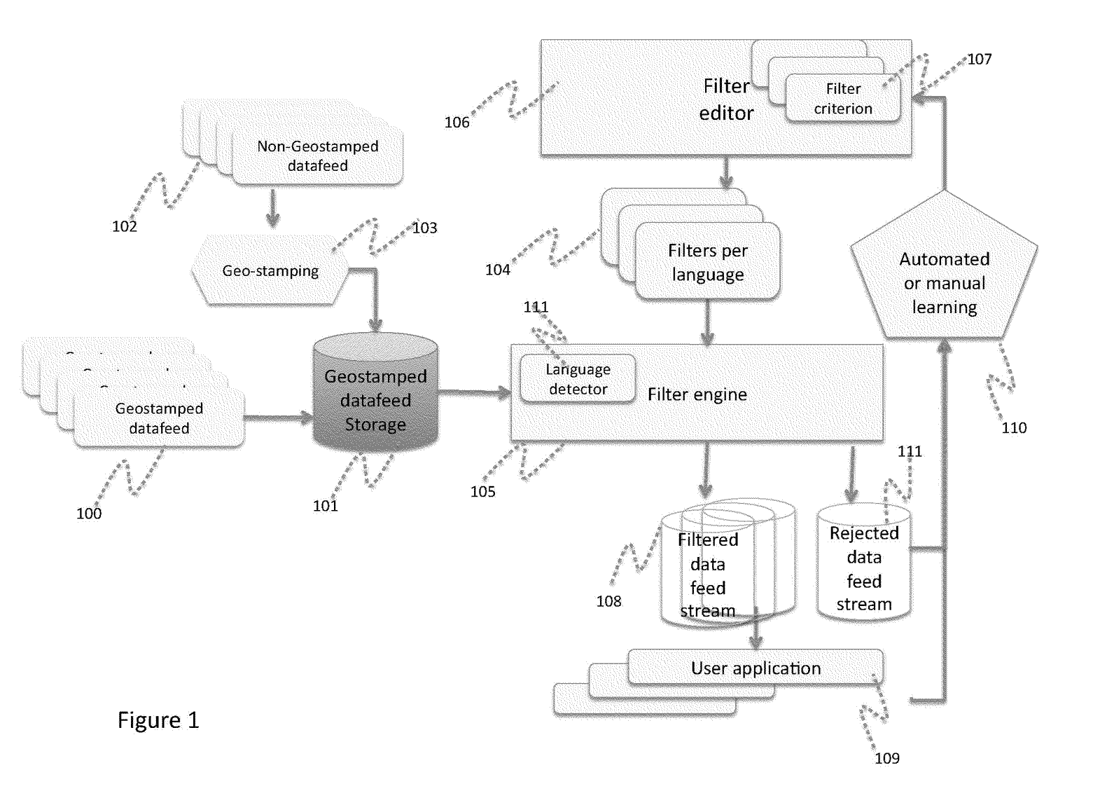

For the purposes of the present invention, a data feed may be broadly considered to be any user-originated information. Typical data feeds include, but are not limited to: comments posted to a discussion forum, comments posted to a social networking site, and blog postings. Any desired data sources may be monitored to harvest the source data feeds. Typical data sources that are contemplated include Real Simple Syndication (RSS) and Atom feeds, social networking sites and discussion forums. Other data sources may be included, as desired. Some data feed are geographically stamped, others are not. The term user and interested party are interchangeable. Referring to FIG. 1, data feeds can be geostamped 100 if they already contain geographical information. Other data feeds 102 may not contain geographical information, there are referred herein as non-geostamped datafeed.

In a first set of embodiments of the present invention, data feeds from a plurality of local sources are collected, stored, indexed and then processed to derive metadata defining a geographical context of each data feed. The geographical metadata is linked to, and stored with its source data feed, to define a geographically augmented data feed.

Each non-geostamped data feed 102 is processed 103 to derive geographical metadata for that feed. This metadata may include specific place names and address information. For example, an RSS feed mentioning a specific restaurant in Montreal, Quebec, may be processed to derive geographical metadata which includes the name of the restaurant and its address (e.g. one or more of its street address, e-mail address and the URL of its web-site). The geographical metadata may also include an aggregation of social activities for that restaurant (e.g. comments, ratings, votes and other similar actions).

Various text recognition methods may be used to identify names of specific places mentioned in any given item of information received from a data source. In some cases, a standard taxonomy may be used to identify place names. In some cases, this approach may by enhanced with predefined rules which may be dynamically loaded depending on the data source, and geographic and language parameters. This process can be recursive if needed to add extra levels of details. Once specific place names have been identified, other information about that specific place (e.g. address and aggregated social activities) can be obtained using known methods, for example by querying one or more databases.

The process generates a resultant data feed that contains the original source information and the encoded geographic metadata, which may, for example, be supplied to various interested parties. The geo-stamped data feed are stored and indexed in a storage media 101.

In a second set of embodiments of the present invention, a plurality of geo-augmented data feeds are collected and processed to derive aggregated data feeds, each of which is relevant to a given geographical context.

Preferably, metadata defining the geographical context 100 follows a predetermined taxonomy and format. This arrangement is advantageous in that it enables data feeds from multiple independent data sources, but having a common geographical context, to be identified and combined to generate an aggregated data feed.

Various methods may be used to combine (or aggregate) geo-augmented data feeds having a common geographical context. In some cases, different aggregation algorithms may be used, depending on the type of information contained in each data feed. For example, many social sites provide a tool by which a user can provide a rating, which may be represented as a numerical value. This type of information can be harvested from a plurality of geo-augmented data feeds having a common geographical context, and combined (e.g. by computing an average rating, or other statistical parameters) to provide an aggregate user rating for that geographical context. Many social sites also allow to post comments. Again, this type of information can be harvested from a plurality of geo-augmented data feeds having a common geographical context, and combined (e.g. by collating the multiple comments into a single document) to provide an aggregate feed of user comments for that geographical context.

In some cases, respective time-stamps associated with each geo-augmented data feed can be used to correlate data feeds in time. This enables the generation of an aggregate data feed which provides a “snap-shot” of user ratings or comments, for example, at a particular time or within a particular time window. For example, an aggregated data feed may be generated which provides a “snap-shot” of ratings or comments immediately following a given event. In another example, time-stamps may be used to generate an aggregated data feed which tracks how user ratings and/or comments change over time.

In some embodiments, a service provider may receive and process multiple geo-augmented data feeds, and generate aggregated data feeds of various types for distribution to its subscribers. For example, a subscriber may establish service agreement which sets out the type(s) of aggregated data feeds (e.g. ratings, comments etc.), the geographical context, and other parameters defining the subscriber's area of interest. Based on the information contained in the service agreement, the service provider can filter and combine geo-augmented data feeds to generate one or more aggregated data feeds or filtered data feeds 108 for distribution to the subscriber.

In a third set of embodiments of the present invention, a plurality of geo-augmented data feeds are collected and processed to derive aggregated data feeds or filtered data feeds 108, each of which is relevant to a given geographical context.

In some cases, one or more aggregate data feeds may be generated and distributed to interested parties via user application 109, for example in accordance with a service agreement between a service provider and a subscriber.

In some cases, an aggregate data feed 108 may contain information that is time-sensitive. For example, an aggregate data feed may contain information of aggregated ratings at a particular time.

In embodiments of the present invention, an aggregate data feed is processed to identify whether or not a predetermined criterion is satisfied. When this event occurs, an alert is generated and sent to an interested party.

In some embodiments, a user or interested party may establish service agreement with a service provider, which includes information defining an alert or notification to be sent to sent to the interested party, and the criteria that must be satisfied to trigger the sending of that notification. For example, the interested party may wish to receive a notification whenever a specific place, competitor name or event is mentioned in an aggregate data feed. Alternatively, the interested party may wish to receive a notification when an aggregated rating about a specific geographical context changes. Numerous other criteria 107, and combinations of criteria or filters 104 can be used to trigger alerts and notifications, as desired, without departing from the intended scope of the present invention.

In a fourth set of embodiments of the present invention, a plurality of geo-augmented data feeds are collected and the unstructured text is filtered to derive filtered data feed streams, each of which corresponds to a set of filter criterion.

Referring again to FIG. 1, a filter engine 105 is used to filter the geo-stamped data feeds to produce a plurality of filtered data feed streams 108. The filter engine parses through unstructured text to find relevant information to direct the feed to one or more appropriate filtered data feed stream 108. The filtered data feed streams 108 are directed to the appropriate user applications 109 based on their requirements. Alternatively, the user application can subscribe to receive one or more filtered data feed stream 108. The filter engine uses one or more filters 104. The filter engine could include a language detector 111 to detect the language of the data feed. In this embodiment, a different set of filters 104 is defined for each language supported by the filter engine 105. Filters are based on one or more filter criterions 107. Criteria 107 are logical equations using specific keywords to extract specific information from the unstructured text such as, for example, merchant category (e.g. “restaurant”, “florist”), a geographical location (e.g. “Boston”), a type of feed (e.g. opportunity versus mention), synonyms or equivalents (e.g. “Bistro”=“Restaurant”), common names, action verbs (e.g. “going to”, “moving”), qualifiers, life events (e.g. “marriage”, “university”), shortcuts, acronyms and other specific text. Filters 104 combine one or more filter criteria in sequence. The filters 104 and filter criterion 107 are defined manually or can be created/edited using an automated filter editor 106. A simple Boolean logic example of filter criterion 107 would be:
(“I'm hungry” OR “I'm starv*” OR “I'm famished” OR “empty stomach” OR “I don't want to cook” OR “I can't cook” OR “I have a date” OR “going to Boston” OR “headed to Boston” OR “restaurant is closed”) OR ((restaurant* OR cafe* OR pub? OR diner* OR bistro* OR eatery OR sushi* OR pizz* OR lunch* OR buffet* OR cater*)

It should be noted that any type of matching criterion could also be used. An example of filter combining the above criterion with other criteria could be:
(“I'm hungry” OR “I'm starv*” OR “I'm famished” OR “empty stomach” OR “I don't want to cook” OR “I can't cook” OR “I have a date” OR “going to Boston” OR “headed to Boston” OR “restaurant is closed”) OR ((restaurant* OR cafe* OR pub? OR diner* OR bistro* OR eatery OR sushi* OR pizz* OR lunch* OR buffet* OR cater*) AND (suggest* OR recommend* OR advice OR propos* OR refer* OR looking OR craving)) AND (boston OR user_city:Boston)

The filters are dependent on the context of what the user is looking for. For example the set of criteria combined to extract data feed relevant to a restaurant owner is different than the set of criteria combined to extract data feed relevant to a florist or a moving company. The criteria are developed and enhanced to take into account what the unstructured text could contain that is relevant to a user in a given market, including synonymous terms, abbreviation, common expressions etc. Another example, a criteria could also include one or more swearing or infuriating words and the corresponding filter will exclude the feeds meeting this criteria.

The filter engine 105 parses the unstructured text of a data feed in near real-time to decide if it meets one or more filters and directs the data feed to the relevant filtered data stream(s) 108. In case a data feed does not meet any filters, it can be optionally sent to a rejected data feed stream 111 for analysis. The automated or manual learning process 110 can analyse the rejected streams to evaluate whether there are missed opportunities and if necessary enhance the relevant filters 104 and criteria 107. The filtered data stream is a sequence of notifications that matches a given filter.

In some embodiments, a notification may include information identifying the event that triggered generation of the notification. This information may include a link to the aggregate data feed which triggered the notification. In some cases this information may include links to the geo-augmented data feeds used to generate that aggregate data feed.

In some embodiments, the user application 109 may provide information about recommended courses of action for responding to the notification (e.g. reply, send rebate coupon, put in calendar for later action). In some cases, this information may be based on previous actions of the recipient of the notification. In other cases, this information may be obtained from a database of recommended actions, which may be developed by another party. For example, a service provider or the user application 109 may generate and maintain a database of recommendations for responding to each one of a set of notification types (e.g. opportunities, mentions). When a notification of a given type is generated and sent to an interested party, the database is queried and the applicable information (or alternatively a link to the applicable information) is inserted into the notification. The reaction to the notification is logged into the reaction management process of the user application 109.

Some user applications 109 may also provide reaction feedback (for example the number of feeds used, feeds that are judged irrelevant etc) to the automated or manual learning engine 110 that will be used to augment or refine or change the filters 104 or criteria 107.

The user application receive or subscribe to one or more filtered data feed streams to receive the relevant notifications. A set of user customized filters 205 can optionally be configured to include additional logic to further narrow the filtered data stream (e.g. include “shawarma” only) and reduce the number of notifications to a customized stream of notifications 207. The notifications from the filtered data stream can be displayed on a web portal 201, or using a push application 202 where the filter engine pushes the information to the application on a regular basis or using a pull application 203 that can fetch the information of the data streams periodically. Another possible implementation consists of providing a text report 204 of all the notifications received during a period. The applications can interface with a reaction management system 206 to extract feedback on the data feed stream to refine the customized users filters 205 or to input to the automated or manual learning system 110.

The automated or manual learning system 110 can be used to refine the list of criteria and the filters. The system uses input from the reaction management process 206 and the rejected data feed stream 111 to update and enhance the criteria 107 and filters 104.

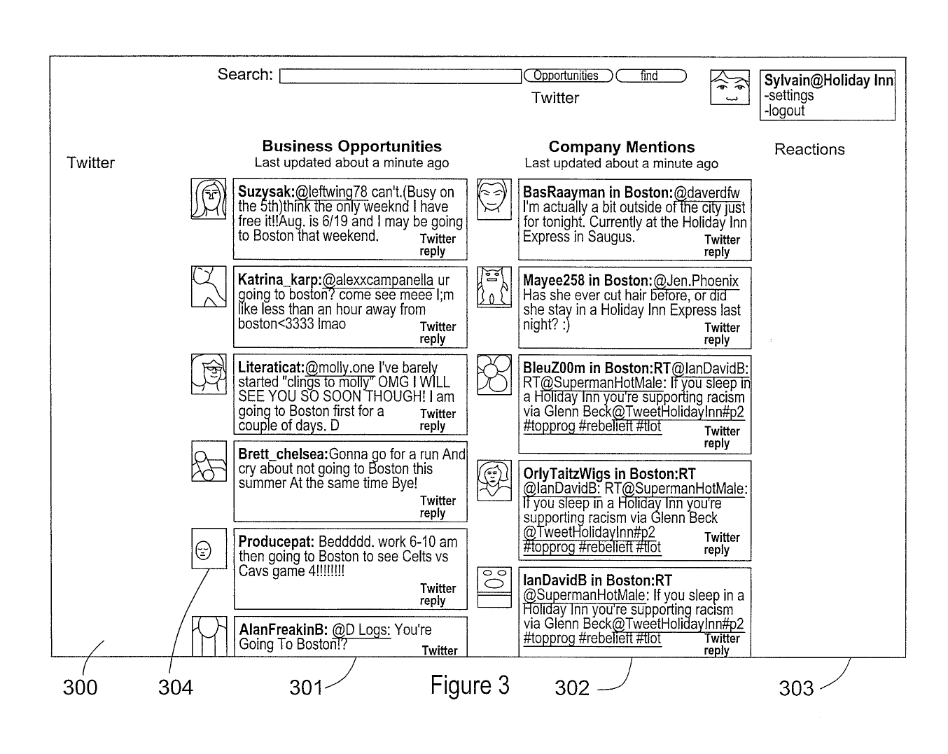

FIG. 3 provides an example screen shot of a simple user application designed to display the notifications from the filtered data feed streams categorized between opportunities and mentions. One part of the screen 300 is used to define which filtered data feed stream to use and to set up customized filters 104. Another part of the screen displays the notifications 304 from the filtered data feed stream that represents opportunities for the user in order of arrival. The third part 302 shows the data feed from filtered data that are actual mentions of the user's company name, for reputation management purpose. The last section of the screen 303 logs the actions taken on one or more data feeds.

The embodiment(s) of the invention described above is(are) intended to be exemplary only. The scope of the invention is therefore intended to be limited solely by the scope of the appended claims.

We claim:

1. A method of aggregating a plurality of data feeds from one or more data sources, comprising:
processing each data feed to derive geographical metadata defining a respective geographical context; and
storing each data feed along with its respective geographical metadata.

2. The method of claimed in claim 1, further comprising:
examining the respective metadata of each geo-augmented stored with each data feed to identify geo-augmented data feeds having a common geographical context; and
combining the identified geo-augmented data feeds to generate a corresponding aggregated data feed.

3. A method for generating a filtered data feed stream from one or more geo-augmented data feeds comprising:
creating one or more filters;
filtering the geo-augmented data feeds based on a selection of one or more of said filters to create a plurality of filtered data streams; and
sending the filtered data streams to one or more user application for presenting.

4. The method of claim 3 further comprising:
detecting a language in said geo-augmented data feed; and
using filters specific to said language to generate said filtered data stream.

5. The method of claim 3 wherein said creating comprises:
defining a plurality of filter criteria; and
combining one or more of said filter criteria into a logical equation.

6. The method of claim 5 wherein said filter criterion includes a location.

7. The method of claim 5 wherein said filter criterion includes a type of business.

8. The method of claim 5 wherein said filter criterion includes a life event.

9. The method of claim 5 wherein said filter criterion includes synonyms or equivalent.

10. The method of claim 5 wherein said filter criterion includes the type of feed.

11. The method of claim 3 wherein said presenting further comprises:
combining one or more filtered data feed stream into a combined stream;
filtering the combined stream using one or more customized user filters to create a plurality of customized notifications; and
displaying the customized notifications.

12. The method of claim 11 wherein said displaying includes preparing a report.

13. The method of claim 11 further comprising providing recommendation on actions to take in response to a displayed notification.

14. The method of claim 11 further comprising managing one or more reaction to the displayed notification.

15. The method of claim 14 wherein said managing includes providing said reactions to an automated learning process.

16. The method of claim 14 wherein said managing includes updating said customized user filters.

17. A system for generating a plurality of filtered data feed stream from one or more geo-augmented data feeds comprising:
a filter editor to create one or more filters;
a filter engine for filtering the geo-augmented data feeds based on a selection of one or more of said filters to created a plurality of filtered data streams; and
one or more user application subscribing to one or more of said filtered data streams.
